(19) United States
(12) Patent Application Publication
(10) Pub. No.: US 2019/0121569 A1
(43) Pub. Date: Apr. 25, 2019

(54) SCALABILITY IMPROVEMENTS OF PEOPLE-COUNTING SENSOR NETWORKS

(71) Applicant: BlueFox, Inc., Saratoga, CA (US)

(72) Inventors: Thomas Sandholm, Saratoga, CA (US); Hang Ung, Saratoga, CA (US)

(21) Appl. No.: 15/792,699

(22) Filed: Oct. 24, 2017

(51) Int. Cl. G06F 3/06; H04W 84/18; H04W 64/00; G06F 17/30; G01S 5/02

(52) U.S. Cl. CPC G06F 3/0652; H04W 84/18; G01S 5/0289; G06F 17/30595; H04W 64/006

(57) ABSTRACT

Disclosed herein is a technique to improve the processing of people counting systems. The technique involves ingesting raw people counting data into a time-series database sorted by point of origin and recorded by end visit time. That raw data is periodically summarized and then written to a relational database. Queries of the relational database for total visitor count over a period of time are modified by approximations of the raw data for particular classes of visitors. Examples of visitor classes include recurring visitors and pedestrians vs. people in cars.

### TECHNICAL FIELD

Teachings relate to electronic data management and more specifically, but not exclusively, to efficient use of network systems to track a number of people over a large number of sensors.

### BACKGROUND

Big data systems, as the name would suggest, generate enormous amounts of raw data. Sensor based, big data systems have intake and processing issues regarding scalability. The intake issue relates to hardware limits in processing reads and writes, as well as geographical concerns regarding positioning of sensors and database servers. People-counting networks have scaling issues regarding data type handling and data interpretation.

### BRIEF DESCRIPTION OF THE DRAWINGS

FIG. 1 is a block diagram illustrating an embodiment of a mobile detection system.

FIG. 2 is a block diagram illustrating a scaled network architecture.

FIG. 3 is a flowchart depicting ingestion and processing of raw data.

FIG. 4 is a flowchart depicting report generation involving summarized data modified by approximated statistics.

FIG. 5 is a graphical representation that demonstrates how known placement of sensors combined with raw data may provide approximation insight.

FIG. 6 is a block schematic diagram of a system in the exemplary form of a computer system within which a set of instructions for causing the system to perform any one of the foregoing methodologies and logical flows may be executed.

### DETAILED DESCRIPTION

Disclosed herein is a technique to improve the processing of people-counting networks. In order to achieve these goals, the network includes optimizations to the ingestion of data, the summarization of data, the querying of the data, and approximations on statistical outcomes of the data.

These optimizations provide an efficient (high scale, low resource consumption) method to summarize a stream of visits (id, start, end, vicinity to origin) with hourly and daily statistics such as number of visits and visitors, recurrence distribution, dwell time distribution, traffic versus pedestrian ratios. Furthermore, the network is able to provide these statistics both for a single stream of data and multiple streams (origins) in aggregate.

The network uses a combination of aggregate measurements and approximations that are computed continuously to provide up-to-date as well as historical analytical reports to serve as assessment as well as insight about events such as marketing campaigns, or public speeches. Each stream is generally produced by a people-counting sensor physically placed at the origin of measurements to measure foot traffic. The network need not be distributed if aggregation across multiple origins is not needed (i.e., a user only cares about the foot traffic in a single location as opposed to the effect of a marketing campaign across an entire state or country).

A problem addressed is how to provide a means to summarize and get insights from visit stream data at large scale. Disclosed is a network that can process data from millions of sensors (origins). In such a system regular databases such as mySQL are not a good fit. Distributed databases such as BigTable, SparQ, Hadoop, or Cassandra require a large cluster of nodes to operate at scale. For single database/node settings such solutions are very resource in-efficient (distribution overhead is hampering performance). A key to an embodiment of the disclosed solution is how to scale from a single to a large set of nodes seamlessly without too much up-front investment.

People-counting sensors can range significantly in character. A simple example of such a sensor is a turnstile. Another simple example is a hand-held clicker with some network connection. Other people-counting systems may make use of motion sensors, or optical sensors making use of computer-vision to identify individuals in an area. Another style of system involves counting devices held by the people being counted. One such style of network counts mobile devices, such as smart phones, based on wireless network signals (cellular/WiFi/Bluetooth/etc.). Since Smart phones are generally ubiquitous in modern society such counting systems are effective.

The scaling optimizations taught herein may be effectively employed with each of people-counting sensor styles discussed above and more. The limits of the sensors are merely that there is some communication (directly or indirectly) with a network server, and that the sensor has some means generate raw data. The raw data varies in complexity based on the sensor system used, but minimally provides a means to obtain a count of people in a particular zone or region around the sensor and includes some reference to time (i.e., direct timestamps, or some record of the time period the sensor was in use).

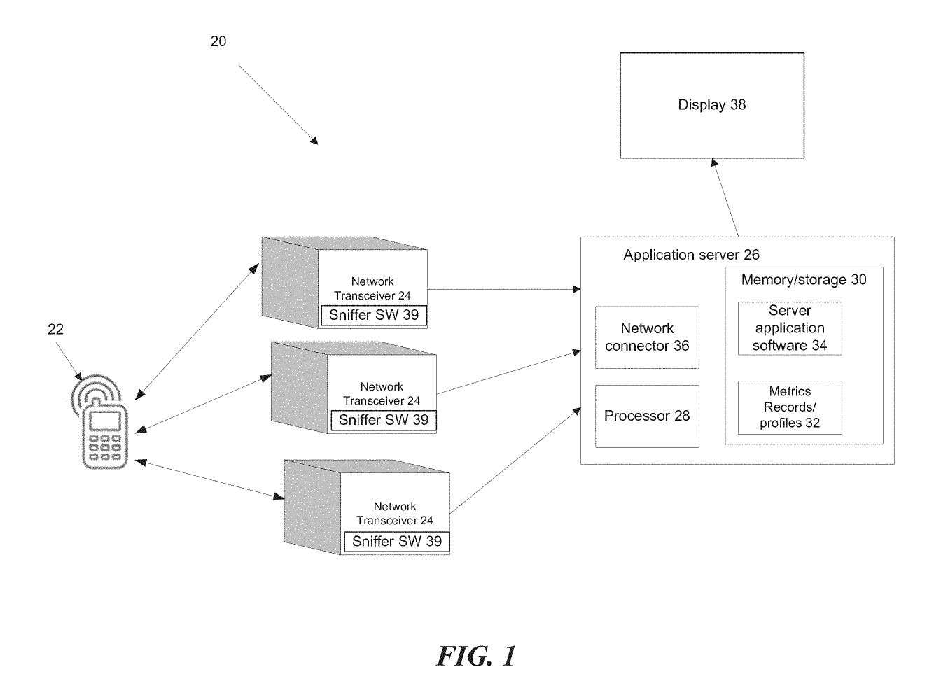

FIG. 1 is a block diagram illustrating an embodiment of mobile detection system 20. The system 20 relates to mobile devices 22 carried on a user's person. The mobile devices 22 are detected by network transceivers 24. Network transceivers 24 are detection devices or mobile stations (MS), which colloquially can be referred to as fake hotspots or sniffers, that collect identification data from mobile devices 22. Data collected by the network transceivers 24 is forwarded to an application server 26 via the Internet. The application server 26 includes a processor 28 and a data storage or memory 30 for logging metrics 32 and running application analytical software 34. The results of the analysis of metrics 32 are displayed or rendered to a user on a display 38.

Mobile devices such as cellular phones, tablets, or other portable networked devices emit signals in Bluetooth, WiFi, and cellular (i.e. 2G, 3G, 4G, Edge, H+, etc.). These signals attempt to connect to paired devices, hotspots, cell towers, or other suitable wireless connection points to greater networks (“hotspots”). In order to connect to hotspots, mobile devices send out identifying data to establish a connection.

If the mobile device is tricked into attempting to connect with a network transceiver disguised as a hotspot, the fake hotspot may unobtrusively collect the identification data of the mobile device (such as a machine identifier) and then reject the connection request. The fake hotspot collects data in real-time on the mobile device, and by association, collects data regarding the human carrying the mobile device. This data collection occurs without alerting or impeding the human carrier. The system uses analytical software to determine, for example, an approaching unique ID user's presence, history, frequency of visits, duration of presence, and so on. The type of data available to the fake hotspots varies based on a number of details, such as the kind of hotspot used.

In some embodiments, a dashboard selects and controls data that is received from the network transceivers 24 at the application server 26. The dashboard can control, from a distance, data captured by the network transceivers 24 as well as new visitor characteristics, history of data used, the number of mobile devices that can be sensed, demographics regarding a selected user, and so on.

The network transceivers 24 may include a plurality of sensors and communicative devices. Examples include wireless fidelity (WiFi) sensors, cell signal 2G, and Femto sensors for 3G and 4G for sensing a user's mobile device 22.

Mobile devices 22 emit WiFi signals automatically. WiFi signals carry identifying data including the MAC address (unique ID number), power of the signal, distance of mobile device 22 from the network transceiver 24, brand of the mobile device 22, name of the mobile device 22 (given by the user), and the network name the mobile device 22 used to connect.

Cell signals (2G, 3G, 4G, etc.) emitted by a phone also occur automatically. The network transceivers 24 detect this signal with an active action on a regular basis to collect the MAC address (unique ID number), SIM card number (IMSI), power of the signal, distance of mobile device 22 from network transceiver 24, carrier, nationality of the mobile device 22, list of applications which attempt to update, and the addresses of the web pages already open (or cached) on the mobile device 22.

Cell signal in this case refers to both CDMA and GSM type networks. While normally CDMA networks would not necessarily use mobile devices 22 with SIM cards, SIM cards exist in devices that use 4G LTE signals. Additionally, in the U.S., CDMA carriers use network-based whitelists to verify their subscribers. The mobile device 22 will still have a unique ID for the carrier to use for identification.

The network transceivers may additionally include processors 28 for internal operations and/or for accepting some of the analytical processing load from the application server 26. Network transceivers 24 may also employ sniffer software 39. Sniffer software 39 includes program operations of the network transceivers 24 as well as network protocol software. Examples of network protocol software include adaptations of OpenBTS (Open Base Transceiver System) and OpenBSC (Open Base Station Controller), with additional features as taught herein. OpenBTS is stable, more complete for GSM, and has a release for UMTS (Universal Mobile Telecommunications System). OpenBTS includes the functionality to perform complete man-in-the-middle attacks. It is worth noting that OpenBSC makes use of OpenBTS for its BTS functionalities.

Using OpenBTS software, examples of base model hardware that may be used for the network transceiver are adaptations of communications platforms manufactured by Ettus Research, Fairwaves, and Nuand.

For cellular signals, there are two distinguishable cases: idle mode and non-idle mode. In idle mode, the mobile device 22 performs the selection and re-selection of a base station to make sure that the mobile device 22 is attached with the best possible channel to the carrier network. In non-idle mode, a mobile device 22, with a point-to-point active call, will perform a base station handover to assure that the call is not dropped.

In order for the mobile device 22 to choose to identify itself to the network transceivers 24, the mobile device 22 has to reselect the cell managed by the network transceivers 24 and push them to identify/authenticate. A set of criteria is defined in the standard mobile phone regarding this selection/re-selection procedure. A BCCH frequency scan can be described as follows: the mobile device 22 scans a set of frequencies to detect a BCCH frequency to camp on. Criteria for cell eligibility can be selected or re-selected. These cells include timing information. In some embodiments, every five seconds, the network transceiver 24 calculates the parameters for the serving cell and for non-serving cells.

GSM, UTRAN, and/or LTE (2G, 3G, 4G) cell reselection is feasible. Therefore, within the sniffer software 39 are programmed, unique approaches for each. According to the network requests, a network transceiver 24 provides specific identification parameters to a fake network (e.g., IMSI or IMEI). The network initiates the identification procedure by transferring an IDENTITY REQUEST message to the network transceiver 24 and starts a timer T3270. The IDENTITY REQUEST message specifies the requested identification parameters in the identity type information element. The IMSI and/or IMEI may be requested.

In some embodiments, the data network includes a wired data network and/or any category of conventional wireless communication networks; for example, radio, Wireless Fidelity (WiFi), cellular, satellite, and broadcasting networks. Exemplary suitable wireless communication technologies include, but are not limited to, Global System for Mobile Communications (GSM), General Packet Radio Service (GPRS), Code Division Multiple Access (CDMA), Wideband CDMA (W-CDMA), CDMA2000, IMT Single Carrier, Enhanced Data Rates for GSM Evolution (EDGE), Long-Term Evolution (LTE), LTE Advanced, Time-Division LTE (TD-LTE), High Performance Radio Local Area Network (HiperLAN), High Performance Radio Wide Area Network (HiperWAN), High Performance Radio Metropolitan Area Network (HiperMAN), Local Multipoint Distribution Service (LMDS), Worldwide Interoperability for Microwave Access (WiMAX), ZigBee, Bluetooth, Flash Orthogonal Frequency-Division Multiplexing (Flash-OFDM), High Capacity Spatial Division Multiple Access (HC-SDMA), iBurst, Universal Mobile Telecommunications System (UMTS), UMTS Time-Division Duplexing (UMTS-TDD), Evolved High Speed Packet Access (HSPA+), Time Division Synchronous Code Division Multiple Access (TD-SCDMA), Evolution-Data Optimized (EV-DO), Digital Enhanced Cordless Telecommunications (DECT), and others.

The sensors can acquire data on the media access control (MAC address), signal strength, timestamp of probes received, and so on, from the mobile device. In some embodiments, the sensors can be integrated into the display device and/or placed as a separate unit collecting data metrics per location and uploading them to the central server. Additional sensors improve the accuracy of the wireless metrics as well as cover multiple areas within a location. Other sensors that can be used include Bluetooth, GSM/2G, and so on.

The raw data available from the network transceiver 24 is rather diverse. A non-exhaustive list of data available includes: a timestamp of detection, point of origin of detection, region of origin of detection, dwell time in the region or point, a detected location of person, a device ID for the detected device, and an exiting timestamp. The character of each of this data may also vary based on sensor. For example, the location of a detected person may be a specific point. This may be calculated from triangulation of three sensors. Alternatively, the person's location may be a distance from a given sensor. This is calculated by signal strength between the network transceiver 24 and the mobile device 22. Additional knowledge of how the network transceiver is positioned can provide additional context to the location.

The device ID may be specific or generalized. An example of a specific device ID is a MAC address, whereas a generalized device ID may be a designation the network transceiver 24, or application server 26 applies to the device. A generalized device ID may have a smaller data size than a MAC address, and thus be an effective tool in scalability of the system. Keeping track of specific points (sensors) and regions (groups of sensors) is also relevant in terms of tracking a given individual within a given region (group of sensors). If a person moves from one sensor to another this may not be interpreted as a new person, but rather a continued stay (dwell time) of the same person. Keep tracking of this at a low level in the network (initial intake server or at the sensor level) reduces the overall data intake of the system and improves the scalability.

The origination point or region may be defined as an original detecting sensor or a group of sensors respectively. The relevance of each depends on the network needs, and placement. Where specificity is important, the particular sensor, or point or origin may be important. In other implementations, a broader answer may be acceptable.

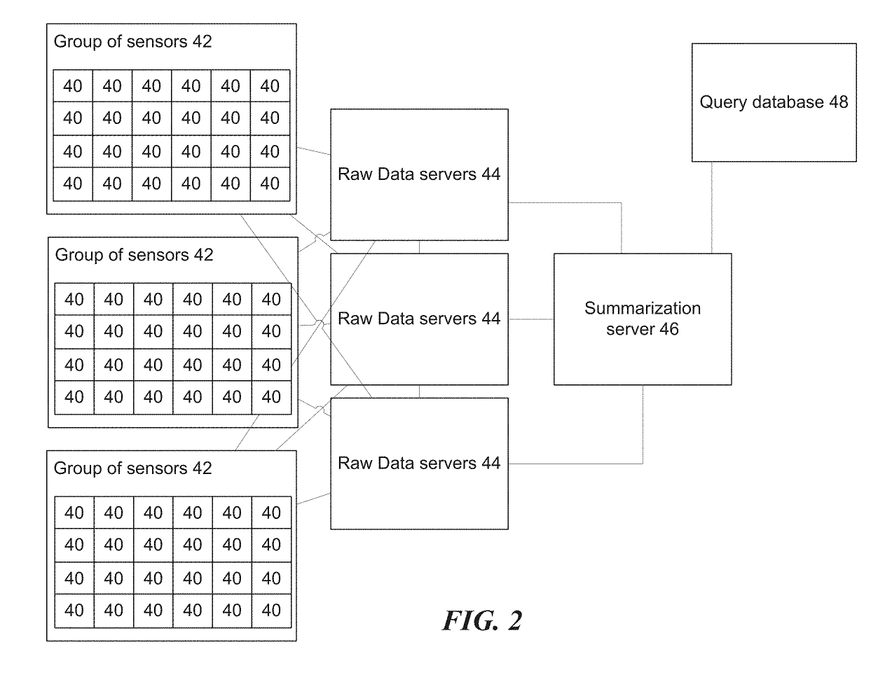

FIG. 2 is a block diagram illustrating a scaled network architecture. At the bottom level, there are a number of individual people-counting sensors 40 sending raw data independently at intervals tagged with sensor IDs. The figure illustrates the sensors 40 as organized into groups of sensors 42. The groups of sensors 42 are determined based on the chosen deployment. For purposes of the figure, the particular grouping of sensors 40 is arbitrary. Considerations involved in the groupings for particular deployments include the sorts of structures people traffic is being monitored in, the geographic range and scope people are being monitored, and the ownership scheme of the sensors 40.

The raw data servers act as a store and forward persistent messaging bus that receives the raw data and batched (groups) based on sensor ID (e.g., point of origin). As data comes into the system at a high rate from many different, potentially geographically distributed locations it is important to aggregate and submit large batches to make the best of available bandwidth. The raw data servers 44 utilize a store and forward messaging system as a first line of defense against high volumes.

The raw data servers 44 make use of a distributed time-series database and are a distributed memory buffering mechanism that collects a stream of visits from a single sensor 40. A single sensor 40 writes sequentially to a single database location. Hence, the raw data servers 44 convert a random access write pattern into a much more efficient sequential write.

To simplify cross-origin aggregation (aggregation by groups of sensors 42) the raw data sensors write each origin in a group of sensors 42 to a “nearby” location. For example, the raw data servers write visits from a given sensor 40 into the same row of a relational database and the visits from the same group of sensors 42 into the same table. In other words the primary key is origin and the secondary key (index) is the group. The raw data servers 44 store the raw data in a time series format, not a relational format. Hence, the raw data is easy to aggregate and range query by time (the high-level primary key is a timestamp).The raw data servers 44 purge records periodically. The purge may be based on a record lifespan, or a database clear. For example, records that are 24 hours old may be deleted, or an entire table may be cleared once every 24 hours.

The summarization servers 46 keep track of ongoing visits, and when the visits end (e.g., a given smart phone goes undetected for ˜10 min). When a visit ends, that visit is written to a column store database on the summarization server 46. Visits are ingested into a persistent index structure optimized for summarization (based on sensor ID), in a time series database. In some embodiments, the ingest and the visit ends may be written to separate databases.

Periodically (e.g., every hour) the summarizations servers 46 batch and summarize the data. The summarization process reduces the available data fields of the raw data. For example, in some embodiments, the batching process reduces the raw data to merely a record of a given visit at a given sensor 40 with a timestamp. This significantly reduces the size of the data making the batched package of data significantly more scalable. The summaries may be enhanced to include data regarding the group of sensors 42, where each sensor 40 can be associated with a number of logical groups, and states can be computed with regards to each group of sensors 42. This additional data has a marginal effect on package size. One method to keep the data size down uses an origin identification scheme whereby a single ID designation denotes both an ID for an individual sensor 40, and the group of sensors 42 to which that sensor 40 belongs.

Periodically, at a rate independent from the batching process (e.g., daily), the query database 48 receives the summarized data packages form the summarization server 46 and writes the package into a relational structure database for reports and queries. Finally, the reports are computed live based on the summarized relational data and modified by mathematical approximations discussed further below.

At each layer of servers 44, 46, 48 progressively reduces the number of servers. The architecture transitions from many servers performing many writes and infrequent reads, to a small group of servers that perform infrequent writes (perhaps once daily) and many reads (prepared each time a user requests a report). In this manner, conflicting writes and reads are reduced and the network scales. At each level, a database structure is used that lends to the sort of raw data that is generated by people-counter sensors 40. The first layer uses a distributed time-series database and the top-level backend servers make use of a relational database.

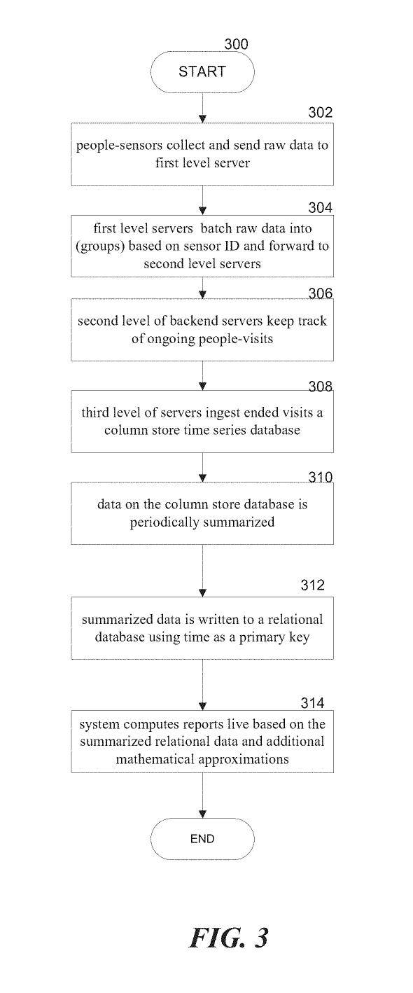

FIG. 3 is a flowchart depicting ingestion and processing of raw data. In step 302, a plurality of people-sensors collect and send raw data independently at fixed intervals tagged with a respective sensor id to a first level of backend servers. In step 304, the first level of backend servers configured as store and forward persistent messaging buses receives the data and batched (groups) based on sensor ID. The data stored and forwarded by the first level of backend servers is made available to a second level of backend servers. In step 306, the second level of backend servers keep track of ongoing people-visits (as determined by the raw data).

In step 308, when visits end (e.g., no detection of device for ˜10 min) the ended visit is written to the next level of backend server. The third level of backend servers ingest the ended visits into a persistent index structure optimized for summarization (based on sensor ID), in a time series database. The time-series database is a column store type database. In step 310, the data on the column store database is periodically (e.g., every hour) summarized. Summarization includes counting the number of completed visits since the last summarization.

In step 312, periodically, though at an independent interval (e.g., daily), the summarized data is written to a relational database using time as a primary key. In step 314, the system computes reports live based on the summarized relational data and additional mathematical approximations.

Relational data bases are good for reporting and can work on summarized data efficiently. However, they are not equipped to handle large volumes of raw data being ingested. Distributed column store databases, like Cassandra, are very resource hungry in small deployments, and do not aggregate time series data as efficiently. Using both styles of database (relational and column store) for respective tasks within the disclosed solution improves the overall scalability of the network and enables computationally inexpensive methods to ingest and report people-counting data.

The summarized data is the base data used to compute statistics, especially statistics over extended periods of time (greater than a day). In some embodiments, the window of processing the raw data is a calendar day. This is a result that the raw data requires significant disk space, and is computationally expensive to query. For some expensive computations the system progressively timestamps a last processed visit to avoid recomputing the statistics across the same visits. Data is ingested in sorted order by location and visit end time to allow progressive processing. Ingesting in this fashion improves ease of aggregation for stats, such as the distribution of dwell times, where bucket counts can be added across arbitrary time ranges. In some embodiments, all the raw data is summarized into hourly and daily counts. For hourly summarization the network may merely provide the raw visitor counts.

Queries are made on the summarized data. This is comparatively less computationally expensive than querying the raw data, and further enables purging of the raw data periodically (as does not required continued use). Daily stats are in summarized and provided through an API that can be used in a reporting system to users. Furthermore, the network may cache the most recent dump of summary stats for clients that just want the most recent summary stats (as opposed to a report).

The queries are run on the recent summary dump or the hourly, daily summaries in the database for quick retrieval. In some embodiments, queries are limited to those with a time scale spanning a day or part of day of data. Other queries access a dump cache. This is because the data is shared daily. Queries on summarized data limited to a single day are computationally cheap. The queries aggregate over time and sum up aggregate stats from shorter time ranges. In some embodiments, the queries are run on both given sensors (point of origin) and/or groups of sensors (region of origin).

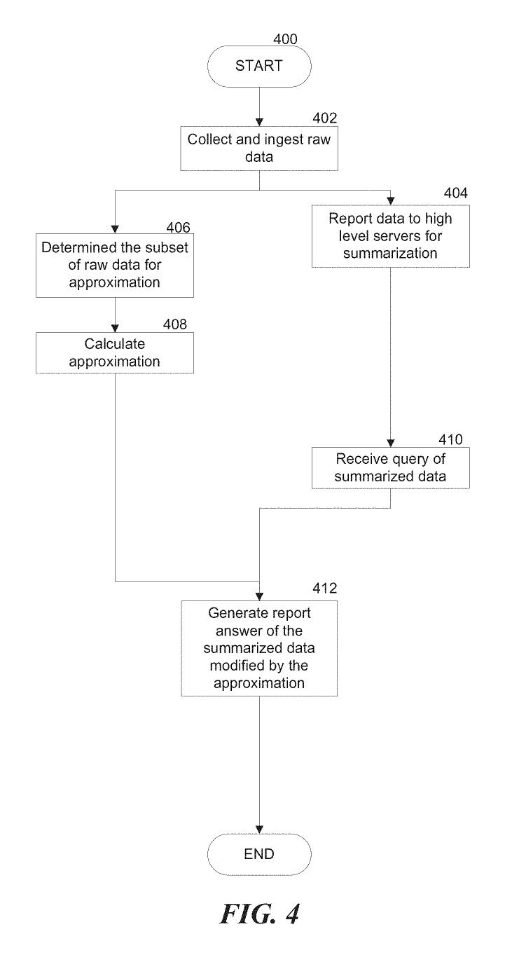

FIG. 4 is a flowchart depicting report generation involving summarized data modified by approximated statistics. Some statistics are difficult to scale. They either cannot be derived from summarized data or are very computationally expensive to run periodically. Thus, to generate this type of statistic, the system will approximate the statistic from the raw data, and then apply the approximation to the reports queried from the summarized data. The manner in which the approximation is used to modify the queried summarized data varies depending on the nature of the query on the summarized data.

In particular, these statistics are those that rely on movements of sensed visits and individual tracking of visit or device IDs. Thus, for two types of statistics: visit recurrence distribution and foot traffic vs car traffic ratios, the system uses approximations. The approximations are measurements and statistics to infer the derived metrics based on models of trained data. In some embodiments, training is performed periodically or for different major deployment types (depending on how the system is implemented and what use the system is being put to). The training uses the raw data, but only a subset of that raw data. Thus, the generation of an approximation is not as computationally expensive as generating a true statistic. Retraining periodically is not necessary if conditions don't change.

In step 402, raw data is ingested. In step 404 the raw data is reported to high level servers and databases and summarized. In step 406, a subset of the raw data is determined based on the deployment style. In some embodiments an arbitrary subset of data is selected. In some deployments a representative subset of data is selected. To determine the subset of the raw data first a time range should be determined. The time range does not need to be linear (e.g., 15 minutes from three different points in a given day may be used).

A time range is to be representative of the population trends that reports are desired for. For example, if the deployment regards marketing in a chain of grocery stores, choosing a time when the stores are generally closed would not be representative. Further only examining a narrow portion of the day would not account for rush hours (e.g., visits after the majority of a population gets off work). Each deployment is unique, and a representative time is determined based on the unique factors that contribute to people-traffic in that deployment.

Similarly, the subset of raw data accounts for points of origin polled. The origin points used in the approximation are also representative. In some deployments, a single sensor is used to represent the raw data, in others multiple sensors or multiple groups of sensors are used. If the deployment is focused on traffic through a stadium, multiple sensors at one or more of the entrances are selected. These sensors may all be grouped together. In another deployment for a chain restaurant, a single sensor from a number of restaurants across multiple states may be selected. Once again, each deployment is unique, and a representative arrangement of sensors is determined based on the unique factors that contribute to people-traffic and geography in that deployment.

In step 408, the approximation is calculated from the subset of the raw data. The approximation returns a percentage of the total that fits a certain visitor class. In step 410, that percentage is applied to the summarized data based on a report query to generate a report.

In step 410, the system receives a query of the summarized data. The query may specify a number of visitors of a particular class over a time period. In step 412 the system generates a report that includes the total visitor population from the summarized data as modified by the approximation to determine the number of visitors in the queried visitor class.

For example, a given report queries the number of pedestrians who have passed through a given point of origin (sensor detection radius) over a particular time period. To execute the query, the summarized data is queried for the total visits over the specified time period (e.g., 10,000). Then, the approximation of the percentage of pedestrians to automobiles (e.g., 60% pedestrians) is applied to that total number. The return to the query is then the total visitors modified by the approximation (e.g., 6,000). The query of the relational database is computationally inexpensive because the data is relatively simple, and sorted only by primary key, whereas the modification by the approximation is a single computation.

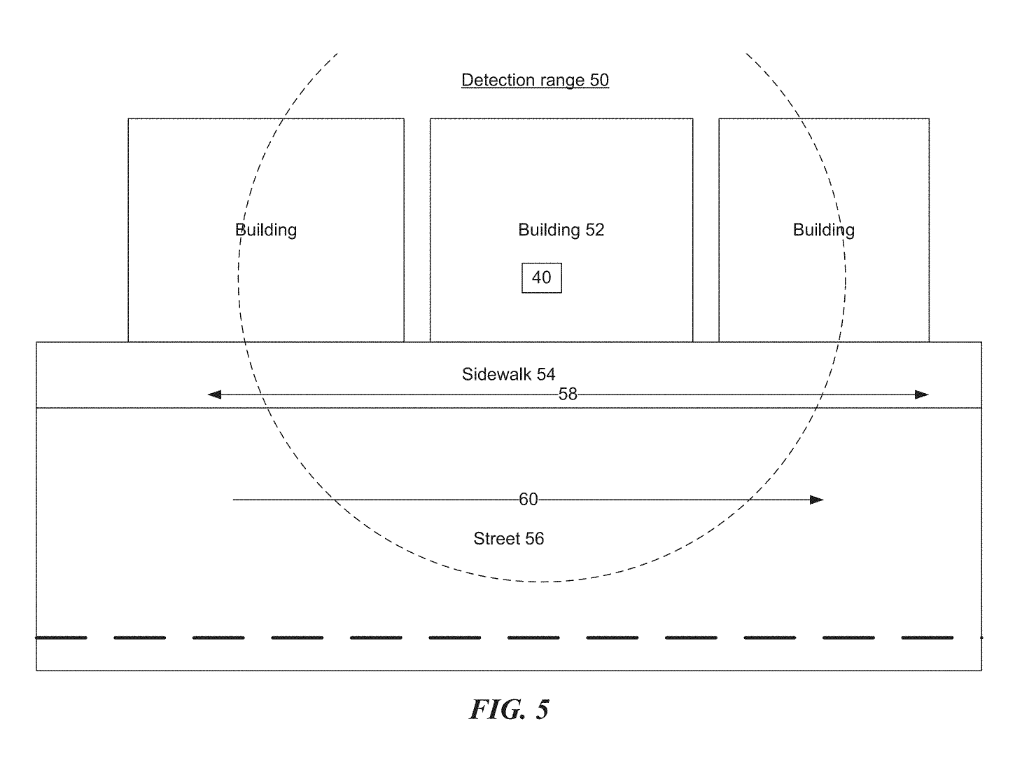

FIG. 5 is a graphical representation that demonstrates how known placement of sensors combined with raw data may provide approximation insight. Given a particular placement where a sensor 40 is positioned in a location with known geography, or where the sensors are placed within a scheme geographically (e.g., at least 15 yards from the nearest street), the raw data may be used to quickly approximate statistics.

A sensor 40, having detection range 50 (depicted by a dotted circle) is placed in a building 52. Outside the building is a sidewalk 54 and a street 56. Pedestrians walking on the sidewalk on path 58 will naturally come closer to the sensor 40 than the drivers of automobiles on the street on driving path 60. Therefore, the system knows that drivers will never have greater than a certain connection strength to the sensor with their mobile devices. Conversely, pedestrians on the sidewalk will have a stronger maximum signal strength. Further, pedestrians who enter the building 52 and approach a display the sensor is positioned on will have a third maximum signal strength. Other geographies lend to the determination of other statistics.

Using this geographic tendency, a subset of the data may be selected (time range and sensors/group of sensors selected). The system does not have perform an exact count of each and may instead apply a function to generate the approximation. For example, in some embodiments if w is the path 58 (visits far away/visits close) rate, then as an example of trained data the: % of cars=0.8−w*0.6.

Recurrence distribution is another statistic that can be approximated via the raw data. Recurrence distribution refers to those people who revisited x times. This approximation enables the summarized data reports to be filtered for unique visitors, new visitors, or merely recurring visitors. The portion of the raw data used is the visit ID or device ID. In some embodiments, visitors are categorized as new or recurring through use of a Bloom Filter. Recurring visits plus unique visits will equal total visits. Recurring visitors exhibit a power law distribution that can be fit by the aggregate daily recurrence across origins and within an arbitrary time range. In some deployments, the time range and points of origin are chosen to be representative as described above. Where:

Given a time period starting tₛₜₐᵣₜ and ending t_{end}

Given a group G of sensors (=locations)

Let vᵢ be the number of visitors who visited i times any of the sensors in G, between tₛₜₐᵣₜ and t_{end}

Let N=Σi*vᵢ=total number of visits, and N_{rec} the subset of visits that are recurrent (visits which are not the first visit of that individual or device ID)

Let r be the group recurrence rate at time t_{end}, i.e. r=N_{rec}/N

The system assumes that vᵢ follows a power law distribution with parameters C and y where C is the number of visitors who visited any of the sensors in G only once and y is the speed of the decrease in the distribution of vᵢ. When y is higher than C people tend to visit less frequently:

vᵢ=C/îY

Therefore, the following relationships exist:

N=Σi*C/îy=ΣC/î(y−1)=C*ζ(y−1) (Riemann zeta function) 1.

r=N_{rec}/N=((i−1)*C/îy)/N=1−ζ(y)/ζ(y−1) 2.

Solving the equations derives values for vᵢ. In some embodiments, the distribution may be revisited on a periodic basis (e.g., daily).

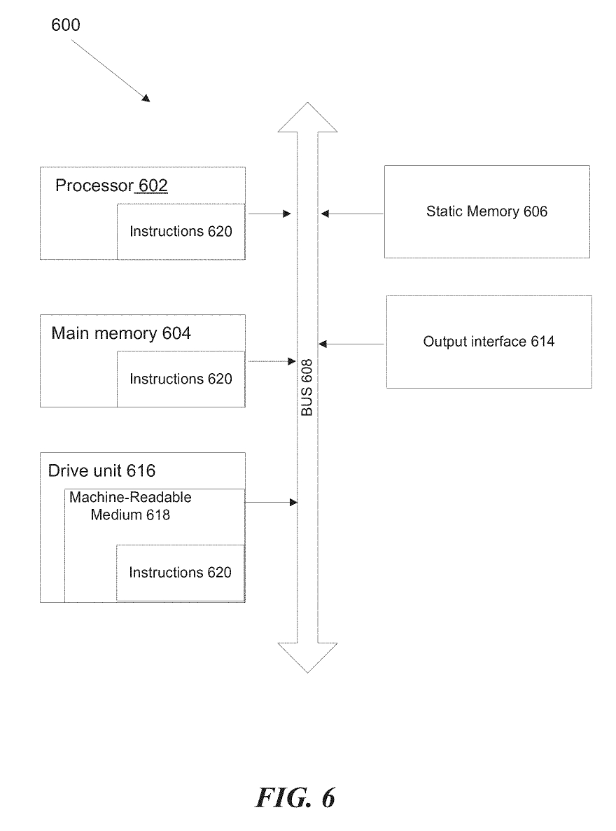

FIG. 6 is a block schematic diagram of a system in the exemplary form of a computer system 600 within which a set of instructions for causing the system to perform any one of the foregoing methodologies and logical flows may be executed.

The computer system 600 includes a processor 602, a main memory 604, and a static memory 606, which communicate with each other via a bus 608. The computer system 600 also includes an output interface 614; for example, a USB interface, a network interface, or electrical signal connections and/or contacts;

The disk drive unit 616 includes a machine-readable medium 618 upon which is stored a set of executable instructions, i.e., software 620, embodying any one, or all, of the methodologies described herein. The software 620 is also shown to reside, completely or at least partially, within the main memory 604 and/or within the processor 602. The software 620 may further be transmitted or received over a network by means of a network interface device 614.

In contrast to the system 600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g., a computer. For example, a machine-readable medium includes read-only memory (ROM); random access memory (RAM); magnetic disk storage media; optical storage media; flash memory devices; electrical, optical, acoustical or other form of propagated signals such as carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations (e.g., requiring cables and complex software configurations, or requiring a consultant to install). For example, embodiments may provide one or more cloud computing solutions that enable users, e.g., users on the go, to access real-time video delivery on such internet-enabled or other network-enabled devices, servers, or clients in accordance with embodiments herein. It further should be appreciated that one or more cloud computing embodiments include real-time video delivery using mobile devices, tablets, and the like, as such devices are becoming standard consumer devices.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

1. A method of improving scalability of people-counting systems comprising:
collecting raw data by a people-counter sensor wherein the raw data includes a timestamp for each detected person and any of:
a point of origin;
a region of origin;
a dwell time;
a location of person;
a device ID; or
an exit time;
storing the raw data in a time-series columnar distributed database keyed to the point of origin;
batching a portion of the raw data into a package, the portion of the raw data included in the package is data pertaining to people visits from a given origin over a period;
aggregating data of a plurality of packages into a relational database of visits to the people-counter sensor keyed to time; and
determining, a number of visitors for a queried group of people-counter sensors wherein the number of visitors is based on query of the relational database modified by approximations of visitor classes, the approximations of visitor classes based on a subset of the raw data.

2. The method of claim 1, further comprising:
purging the raw data from the distributed database on a periodic basis.

3. The method of claim 1, wherein user queries for the number of visitors only access the relational database.

4. The method of claim 3, wherein queries of the relational database specify only a first time period and a first group of people-counter sensors.

5. A system of improving scalability of people-counting systems comprising:
a people-counter sensor positioned at a field location and configured to collect raw data, wherein the raw data includes a timestamp for each detected person and any of:
a point of origin;
a region of origin;
a location of person;
a dwell time;
a device ID; or
an exit time;
a plurality of distributed database servers configured to intake and store the raw data in a time-series database wherein the raw data in the distributed database servers is discarded after a first period of time;
generating approximations of statistics of a class of visitor represented in the raw data based on the raw data;
a batching module in communication with the distributed database and configured to batch a portion of the raw data into a package, the portion of the raw data included in the package is data pertaining to people visits from a given origin over a period; and
a relational database server in communication with the batching module and configured to write data of a plurality of packages into a relational database supporting queries of a number of visits to the people-counter sensor keyed to time.

6. The system of claim 5, wherein time is sortable by hours or days.

7. The system of claim 5, wherein the plurality of distributed database servers are configured to purge the raw data on a periodic basis.

8. The system of claim 5, wherein user queries for the number of visitors only access the relational database.

9. The system of claim 8, wherein queries of the relational database include specify only a first time period and a first group of people-counter sensors.

10. A method of improving scalability of people-counting systems comprising:
collecting raw data by a people-counter sensor wherein the raw data includes a timestamp for each detected person and any of:
a point of origin;
a region of origin;
a dwell time;
a location of person;
a device ID; or
an exit time;
storing the raw data in a time-series column database;
summarizing the raw data in the time-series column database to generate summarized data; and
writing, the summarized data to a relational database server wherein the relational database is queryable by an end user.

11. The method of claim 10, wherein the summarized data includes less fields than the raw data and has a smaller data size than raw data corresponding to a same time period.

12. The method of claim 11, wherein the fields included in the summarized data are timestamp and point of origin.

13. The method of claim 10, wherein the belongs time-series column database is supported on a distributed group of servers, wherein the distributed group of servers are a buffering mechanism of the raw data for the relational database.

14. The method of claim 10, wherein the time-series column database uses the point of origin field as a primary key, and the region of origin field as a secondary key.

15. The method of claim 10, further comprising:
purging raw data that is 24 hours old from the time-series column database.

16. The method of claim 10, wherein said summarizing occurs hourly and includes a portion of the raw data collected and stored within the last previous hour.

17. A method of improving scalability of people-counting systems comprising:
collecting raw data by a people-counter sensor wherein the raw data includes a timestamp for each detected person and fields including any of:
a point of origin;
a region of origin;
a dwell time;
a location of person;
a device ID; or
an exit time; and
generating approximations of statistics of a class of visitor represented in the raw data based on the raw data;
determining, a count of visitors for a first group of people-counter sensors over a first time period based on a query of a database including a summarized version of the raw data; and
modifying the count of visitors based on said approximations.

18. The method of claim 17, wherein the class of visitor represented in the raw data is a percentage of counted people whom are pedestrians, and wherein said generating approximations is performed by:
evaluating the location of person field of the raw data wherein the raw data includes each person detected from a second time period and a second group of people-counter sensors, wherein each person detected at less than a threshold distance from the people-counter sensor is evaluated as a pedestrian; and
determining a ratio of pedestrians to non-pedestrians based on said evaluation of the location of person field wherein the ratio is used to approximate the class of visitor over a greater time period than the second time period for the second group of people-counter sensors.

19. The method of claim 18, wherein the first time period and the second time period are different, and wherein the second group of people-counter sensors is representative of the first group of people-counter sensors.

20. The method of claim 17, wherein the class of visitor represented in the raw data is a percentage visitor whom are recurring visitors, and wherein said generating approximations is performed by:
evaluating the device ID field of the raw data wherein the raw data includes each person detected from a second time period and a second group of people-counter sensors, wherein each person detected at less than a threshold distance from the people-counter sensor is evaluated as a pedestrian; and
determining a ratio of visit recurrence based on said evaluation of the device ID field wherein the ratio is used to approximate the class of visitor over a greater time period than the second time period for the second group of people-counter sensors.

21. The method of claim 20, wherein the first time period and the second time period are different, and wherein the second group of people-counter sensors is representative of the first group of people-counter sensors.

22. The method of claim 20, further comprising:
estimating a number of unique visitors based on the number of visitors modified by the approximated visitor class.

23. The method of claim 17, wherein the approximations of visitor class are periodically updated based on a recent subset of the raw data.
